(19) United States
(12) Patent Application Publication
(10) Pub. No.: US 2016/0189172 A1
(43) Pub. Date: Jun. 30, 2016

(54) SENTIMENT ANALYSIS

(71) Applicant: EBAY INC., San Jose, CA (US)

(72) Inventor: ROY CAMP, Cupertino, CA (US)

(21) Appl. No.: 14/585,567

(22) Filed: Dec. 30, 2014

(51) Int. Cl. G06Q 30/02; G06K 9/00; G06N 5/04

(52) U.S. Cl. CPC G06Q 30/0201; G06N 5/04; G06K 9/00302

(57) ABSTRACT

A method may include analyzing images of a setting that are captured by an image capture system. The method may further include determining, based on the analysis of the images, non-verbal expressions captured in the images. The non-verbal expressions may be of a person in response to a stimulus perceived by the person. The method may also include determining a sentiment of the person with respect to the stimulus based on the non-verbal expressions. In addition, the method may include determining, based on the determined sentiment, a suggested action with respect to the stimulus, the person, or a combination of the stimulus and the person.

### FIELD

The embodiments discussed herein are related to sentiment analysis.

### BACKGROUND

Many business strategies are focused on customer satisfaction. As such, determining and responding to customer sentiment to improve customer satisfaction is often a goal of businesses.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system configured to determine and use sentiment of a person;

FIG. 2 illustrates a block diagram of an example computing system;

FIG. 3 is a flowchart of an example method to determine a suggested action; and

FIG. 4 is a flowchart of another example method to determine a suggested action.

### DESCRIPTION OF EMBODIMENTS

Some embodiments described herein may relate to systems or methods configured to determine a sentiment of a person with respect to a stimulus that may be perceived by the person. The determined sentiment may be used to improve the person's satisfaction with respect to the stimulus.

In particular, according to at least one embodiment, an image capture system may be configured to capture images. Additionally or alternatively, a computing system may be configured to analyze the images. In some embodiments, the computing system may be configured to analyze the images in real time. The computing system may also be configured to determine non-verbal expressions captured in the images based on the analysis of the images. The non-verbal expressions may be non-verbal expressions of a first person in response to a stimulus perceived by the first person. The computing system may additionally be configured to determine a sentiment of the first person with respect to the stimulus based on the non-verbal expressions. Moreover, the computing system may be configured to determine, based on the determined sentiment, a suggested action with respect to the stimulus, the first person, or a combination of the stimulus and the first person. In some embodiments, the suggested action may include recommending performance of the suggested action while the stimulus is being perceived by the first person.

Additionally or alternatively, one or more embodiments described herein may include generating, in response to the determined sentiment, a notification for a second person. The notification may indicate the stimulus and the sentiment of the first person with respect to the stimulus. In some embodiments, the notification may be generated while the stimulus is being provided to the first person.

In these or other embodiments, the determined sentiment and the stimulus may be included in a profile of the person. Additionally or alternatively, the profile may be used to determine the suggest action with respect to the stimulus. Further, in some embodiments, the determined sentiment with respect to the stimulus may be used to determine a suggested action for a second person who may have one or more attributes that are the same as or similar to one or more attributes of the first person.

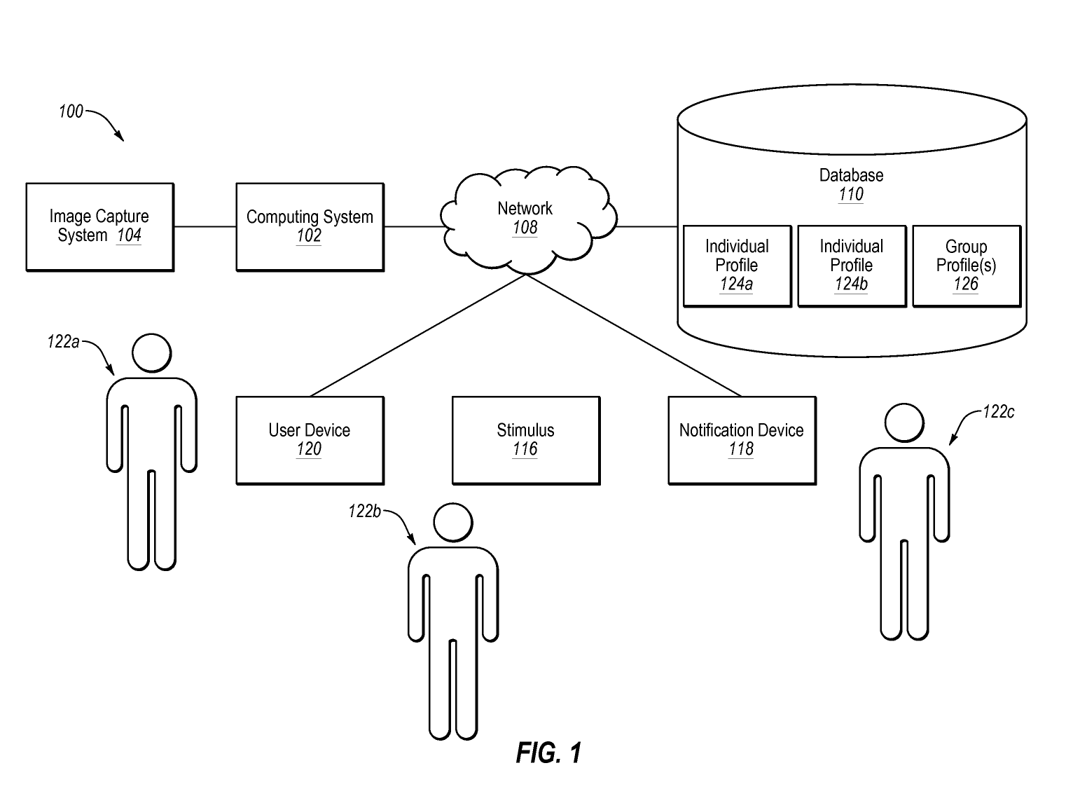

Turning to the figures, FIG. 1 illustrates an example system 100 configured to determine and use sentiment of a person. The system 100 may be arranged in accordance with at least one embodiment described herein. In some embodiments, the system 100 may include a computing system 102, an image capture system 104, a network 108, a database 110, a user device 120, and a notification device 118.

In general, the system 100 may be configured to determine a sentiment of a person 122a with respect to a stimulus 116 that may be perceived by the person 122a. The determined sentiment may be used to determine a suggested action to perform with respect to the person 122a, with respect to one or more other persons, with respect to the stimulus 116, or with respect to any combination thereof. The suggested action may be such that a perceived experience of a person with respect to the stimulus 116 may be improved.

The stimulus 116 may include any sort of object, combination of objects, action, sound, smells, taste, or situation, among other things that may be perceived by any of the senses of a human that may affect a sentiment of a person. For example, the stimulus 116 may include an audio stimulus, a visual stimulus, a tactile stimulus, a flavor stimulus, a situation in which the person has been placed, or any combination thereof. Some other examples of the stimulus 116 may include an advertisement, an arrangement of items, a display, a picture, a video, a movie, a television commercial, a television program, a food, a beverage, a layout of an environment, a line, a wait time, a product, a service, packaging of an item, a purchasing experience, an outing, an interaction with one or more other persons, an event, etc. In the present disclosure, reference to “perceiving” the stimulus 116 may include, viewing the stimulus 116, hearing the stimulus 116, touching the stimulus 116, tasting the stimulus 116, consuming the stimulus 116, experiencing the stimulus 116, participating in the stimulus 116, attending the stimulus 116, etc.

In some embodiments, a sentiment of the person 122a with respect to the stimulus 116 may indicate the feelings of the person 122a toward the stimulus 116. For example, the sentiment may include a like or dislike of the stimulus 116. The sentiment may also include interest or disinterest in the stimulus 116. In some instances, the sentiment may be indicated based on an affective state of the person 122a. For example, different affective states may include anger, contempt, disgust, boredom, indifference, happiness, sadness, other emotions, etc., each of which may indicate the sentiment of the person 122a with respect to the stimulus 116.

In some embodiments, the sentiment of the person 122a with respect to the stimulus 116 may include the affective state that the stimulus 116 may elicit. For example, the stimulus 116 may elicit an emotional affective state of the person 122a. Therefore, the sentiment of the person 122a with respect to the stimulus 116 may include the emotional affective state in some embodiments.

One or more elements of the system 100 may communicate with each other via the network 108. The network 108 may include any interconnecting system capable of transmitting audio, video, signals, data, messages, or any combination of the preceding. For example, the network 108 may include all or a portion of a public switched telephone network (PSTN); a public or private data network; a local area network (LAN); a metropolitan area network (MAN); a wide area network (WAN) (e.g., the Internet), or other interconnected data paths across which multiple devices and/or entities may communicate. In some implementations, the network 108 may include a peer-to-peer network. The network 108 may also be coupled to or may include portions of a telecommunications network for sending data in a variety of different communication protocols. In some embodiments, the network 108 may include Bluetooth® communication networks or a cellular communications network for sending and receiving communications and/or data including via short message service (SMS), multimedia messaging service (MMS), hypertext transfer protocol (HTTP), direct data connection, wireless application protocol (WAP), e-mail, etc. The network 108 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 108 may include one or more IEEE 802.11 wireless networks.

In some embodiments, the image capture system 104 may be configured to capture images of a setting that may include the person 122a and the stimulus 116. In these or other embodiments, the image capture system 104 may be configured to capture the images of the setting while the person 122a is perceiving the stimulus 116. The image capture system 104 may be configured to capture images that include the person 122a and the stimulus 116 or that include the person 122a but not the stimulus 116.

The image capture system 104 may include any suitable system, apparatus, or device configured to capture images. For example, the image capture system 104 may include any suitable still-shot camera or video camera configured to capture images. Additionally or alternatively, in some embodiments, the image capture system 104 may include an ultrasonic system, a laser system, an infrared system, or a radar system that may construct images of a setting based on ultrasonic signals, lasers, heat, radar signals, etc. that may be introduced into and/or detected in the setting. As such, the ultrasonic system, the laser system, the infrared system, or the radar system may be configured to capture images through the construction of the images.

The computing system 102 may be configured to determine the sentiment of the person 122a with respect to the stimulus 116 based on the images that may be captured by the image capture system 104. For example, the computing system 102 may be configured to analyze the images to determine one or more non-verbal expressions of the person 122a that may be manifest by the person 122a during perception of the stimulus 116. The non-verbal expressions may include body language, body movements, eye movement, facial expressions and the like, which may be determined according to any suitable methodology. Additionally or alternatively, the non-verbal expressions may include eye dilation, heart rate, respiratory rate, etc. which may be determined from the images according to any suitable methodology.

The computing system 102 may be configured to determine the sentiment of the person 122a based on the determined non-verbal expressions of the person 122a. For example, facial expressions or body language (e.g., movements, stances, positions, etc.) of the person 122a may indicate an affective state of the person 122a. The computing system 102 may accordingly determine the sentiment of the person 122a based on the affective state of the person 122a that may be indicated by the facial expressions or body language.

The computing system 102 may be configured to determine the affective state based on facial expressions or body language based on any appropriate methodology. For example, in some embodiments, the computing system 102 may be configured to compare the determined facial expressions or body language with a control sample. The control sample may include one or more facial expressions, one or more body movements, or one or more body positions and correlating affective states. For instance, the control sample may include facial expressions and/or body movements that correlate with affective states of anger, sadness, happiness, contempt, disgust, indifference, boredom, emotion, etc. As such, the computing system 102 may be configured to compare the determined facial expressions or body language with those of the control sample to find a match or a closest match. The computing system 102 may then be configured to correlate the affective state that corresponds to the match in the control sample with an affective state of the person 122a. The computing system 102 may additionally be configured to correlate a particular sentiment with the correlated affective state such that the computing system 102 may be configured to determine a sentiment of the person 122a with respect to the stimulus 116.

For example, the computing system 102 may be configured to correlate a happy or emotional affective state with a positive sentiment of the person 122a liking the stimulus 116. Conversely, the computing system 102 may be configured to correlate an angry, sad, disgusted, bored, or contemptible affective state with a negative sentiment of the person 122a disliking the stimulus 116.

As another example, the images may include the person 122a walking past the stimulus 116 and may also indicate that the person 122a pauses or slows down upon perceiving the stimulus 116. As such, the computing system 102 may determine a positive sentiment of interest in the stimulus 116. Conversely, the computing system 102 may be configured to determine a negative or neutral sentiment of disinterest when the images indicate that the person 122a does not changing pace or does not glancing toward the stimulus 116.

Additionally or alternatively, the computing system 102 may be configured to determine the affective state or sentiment of the person 122a based on the determined heart rate, respiratory rate, eye movement, or eye dilation of the person 122a. For example, increased heart rate, respiratory rate, or eye dilation of the person 122a may indicate an excited affective state of the person 122a, which may be correlated with an engaged sentiment with respect to the stimulus 116. Conversely, a slow heart rate or respiratory rate may indicate a less excited affective state of the person 122a, which may be correlated with a less interested sentiment with respect to the stimulus 116. Additionally or alternatively, eye movements of the person 122a that repeatedly move toward the stimulus 116 or that maintain a relatively constant gaze on the stimulus 116 may indicate increased interest in the stimulus 116 as compared to little to no eye movements toward the stimulus 116 when the person 122a has less interest in the stimulus 116.

In these or other embodiments, the computing system 102 may be configured to verify or augment a sentiment determination based on the determined heart rate, respiratory rate, eye movement or eye dilation of the person 122a. For example, the computing system 102 may determine an affective state of contempt based on facial expressions or body language of the person 122a. The computing system 102 may also analyze eye movements (e.g., rolling of the eyes) of the person 122a to verify or augment this determination. As another example, the computing system 102 may determine an affective state of anger of the person 122a based on body language or facial expressions of the person 122a. The computing system 102 may also analyze heart rate, respiratory rate, etc. of the person 122a to determine whether or not those are elevated to help verify the determination.

Further, the heart rate or respiratory rate of the person 122a may give an indication of a degree of an affective state of the person 122a. For example, the affective state may be determined as contempt, which may have corresponding facial expressions or body language that are relatively subtle and that may not indicate a degree of contempt. However, the heart rate or the respiratory rate may indicate that the person 122a may be more angry or disgusted than the facial expressions or body language may indicate. Therefore, the heart rate or the respiratory rate of the person 122a may be used to augment the contempt determination of the person 122a. As another example, the facial expressions or body language of the person 122a may indicate nominal interest in the stimulus 116, however the heart rate or respiratory rate may indicate more interest than what may be determined based on the facial expressions or body language.

In some embodiments, the computing system 102 may be communicatively coupled to the image capture system 104 such that the computing system 102 may receive the images directly from the image capture system 104. In some embodiments, the computing system 102 may be communicatively coupled to the image capture system 104 via a direct connection as illustrated in the example embodiment. Additionally or alternatively, the computing system 102 may be communicatively coupled to the image capture system 104 via the network 108.

In these or other embodiments, the computing system 102 may be configured to receive the images approximately as the images are being captured such that the computing system 102 may configured to analyze the images in “real-time.” For example, the computing system 102 may be configured to receive the images from the image capture system 104 in real-time. The computing system 102 may be configured to determine the non-verbal expressions of the person 122a as the images are being received such that the computing system 102 may be configured to determine the sentiment of the person 122a with respect to the stimulus 116 at substantially the same time that the person 122a is perceiving the stimulus 116.

Often there may be a delay between when images are captured by the image capture system 104 and when they are received and analyzed by the computing system 102, even when the images are being fed to the computing system 102 as they are being captured. Therefore, in the present disclosure, use of the term “real-time” with respect to the images indicates that the images may be communicated to the computing system 102 at least roughly as the images are being captured and that the operations may be performed with respect to the images at least roughly as they are received by the computing system 102, while also allowing for any possible delays that may occur during such process, such as network delays, computing delays, and other typically time delays associated with data processing.

In some embodiments, the computing system 102 may be configured to generate a notification that indicates the sentiment of the person 122a with respect to the stimulus 116. In some embodiments, the computing system 102 may be configured to communicate (e.g., via the network 108) the notification to the notification device 118. The notification device 118 may include any suitable system, apparatus, or device that may be configured to receive the notification and provide an indication of the notification or present the notification. For example, the notification device 118 may include a smart phone, a table computer, a desktop computer, a laptop computer, a smart watch, smart glasses (e.g., Google Glass®), etc.

In some embodiments, the notification may be perceived by a person 122c via the notification device 118. In some instances, the person 122c may be in a position to modify the stimulus 116 or to interact with the person 122a such that the person 122c may perform an action with respect to the person 122a, the stimulus 116, or a combination of the person 122a and the stimulus 116 based on the sentiment indicated in the notification.

For example, the notification may indicate that the person 122a is unhappy with respect to the stimulus 116. The person 122a may accordingly take some action to change the stimulus 116 or to interact with the person 122a to change the affective state of the person 122a or to try to avoid another person having a similar sentiment toward the stimulus 116. In some embodiments, the computing system 102 may be configured to communicate the notification to the notification device 118 while the person 122a is perceiving the stimulus 116 such that the experience of the person 122a may be improved in real time.

In some embodiments, the stimulus 116 may include an interaction of the person 122a with the person 122c. The notification may accordingly indicate, to the person 122c, sentiment of the person 122a with respect to the interaction. As such, the person 122c may adapt his behavior according to the notification. For example, the notification may indicate that the person 122a is not happy, which may not be noticed by the person 122c, such that the person 122c may interact with the person 122a in a different manner.

Additionally or alternatively, in some embodiments the computing system 102 may be configured to determine one or more non-verbal expressions of the person 122c while the person 122c is interacting with the person 122a. The computing system 102 may be configured to determine an affective state or perceived affective state of the person 122c based on the non-verbal expressions of the person 122c. In some embodiments, the notification to the person 122c may include the determined affective state of the person 122c. Therefore, the person 122c may be made aware of how his non-verbal expressions may be perceived by the person 122a. As such, the notification may also provide an increased degree of self-awareness for the person 122c.

In these or other embodiments, the computing system 102 may also be configured to analyze changes in the sentiment of the person 122a with respect to changes in the non-verbal expressions of the person 122c. Additionally, the computing system 102 may be configured to correlate the changes in the sentiment with the changes in the non-verbal expressions of the person 122c. As such, the computing system 102 may be configured to determine which non-verbal expressions by the person 122c may elicit certain sentiments of the person 122a such that sentiment of the person 122a with respect to non-verbal expressions of the person 122c may be determined.

In some embodiments, the notification may be communicated to the person 122c via the notification device 118 while the stimulus 116 is being perceived by the person 122a. Therefore, the person 122c may be able to respond to the sentiment of the person 122a with respect to the stimulus 116 in substantially real time in some embodiments.

In some embodiments, the computing system 102 may be configured to determine a suggested action with respect to the person 122a, the stimulus 116, or a combination of the stimulus 116 and the person 122a based on the determined sentiment. For example, the stimulus 116 may include a display and the determined sentiment may indicate a negative sentiment toward the display such that the suggested action may include a suggestion to change the display.

As another example, the stimulus 116 may include one or more checkout lines at a vendor and the computing system 102 may be configured to determine the sentiment of the person 122a (among other persons) in the checkout lines. In response to a negative sentiment determination with respect to the checkout lines, the computing system 102 may be configured to generate a suggested action of opening more checkout lines.

As another example, the sentiment analysis may indicate that the person 122a is happy or unhappy with respect to the stimulus 116. The suggested action may include a suggestion to go talk to the person 122a to find out reasons why the person 122a may be happy or unhappy with respect to the stimulus 116.

As another example, the stimulus 116 may include a food, a beverage, a service, or a product. The computing system 102 may determine that the person 122a likes the food, beverage, service, or product based on the determined sentiment with respect to the stimulus 116. The computing system 102 may determine a suggested action of providing incentives (e.g., coupons, discounts, etc.) for the person 122a to purchase the stimulus 116. Additionally or alternatively, the computing system 102 may be configured to determine similar or complementary stimuli with respect to the liked stimulus 116. In these or other embodiments, the suggested actions may include providing recommendations of the similar or complementary stimuli to the person 122a and/or providing incentives for the person 122a to purchase the similar or complementary stimuli.

As another example, when the stimulus 116 includes an interaction between the person 122a and the person 122c, the suggested action may include a modification of behavior of the person 122c. For example, the computing system 102 may determine that a particular non-verbal expression by the person 122c is favorably or unfavorably received by the person 122a. As such, the computing system 102 may be configured to determine a suggested action to continue or discontinue the non-verbal expression depending on whether or not the sentiment is positive or negative.

In some embodiments, the computing system 102 may be configured to implement the suggested action. For example, the stimulus 116 may include an electronic display at a storefront that may be communicatively coupled to the computing system 102 (e.g., via the network 108). The computing system 102 may be configured to change what is being presented on the electronic display according to the suggested action. Additionally or alternatively, the computing system 102 may be configured to include the suggested action in the notification that may be communicated to the person 122c.

Additionally or alternatively, the suggested action may include a suggestion to perform the suggested action while the stimulus 116 is being perceived by the person 122a. In these or other embodiments, the computing system 102 may be configured to implement the suggested action while the stimulus 116 is being perceived by the person 122a. Therefore, in some embodiments, the system 100 may be configured to respond to sentiment of the person 122a with respect to the stimulus 116 in substantially real time.

In some embodiments, the computing system 102 may also be configured to determine one or more attributes of the person 122a. The attributes may include demographic attributes, financial attributes, interests, etc. of the person 122a. For example, in some embodiments, the attributes may include: name, address, age, race, gender, economic status, social status, socioeconomic status, purchase history, browsing history, health conditions, goals, travel plans, travel history, a calendar, event attendance history, a current planned purchase, employment history, profession, education level, employer, educational institutions attended, affiliations, use patterns of an electronic device, previously determined sentiments with respect to previously perceived stimuli, preferences, planned attendance of an upcoming event, etc. In the present disclosure reference of “determining” an attribute may refer to making a determination that may approximate the attribute and does not necessarily mean that the actual attribute of the person 122a is determined with 100% accuracy.

In these or other embodiments, the computing system 102 may be configured to determine one or more of the attributes based on the images that may be captured by the image capture system 104. For example, the computing system 102 may be configured to determine an age range, a gender, or a race of the person 122a based on the images. In these or other embodiments, the computing system 102 may be configured to determine apparel of the person 122a such that one or more fashion preferences of the person 122a may be determined.

Additionally or alternatively, the computing system 102 may be configured to determine one or more attributes of the person 122a based on communications that may be received from the user device 120. Examples of the attributes may include identification information of the person 122a, address information, geographic location, or account information of an account that may be held by the person 122a. Other examples may include usage patterns on the user device 120, purchases made on the user device 120, etc.

The user device 120 may include any suitable electronic device that may be associated with the person 122a. The user device 120 may be communicatively coupled to the computing system 102. In some embodiments, the computing system 102 may be associated with an application stored on the user device 120 and the person 122a may grant the computing system 102 access to certain types of information based on permissions included in the application such that the computing system 102 may determine one or more attributes that may be included in the information.

In these or other embodiments, the computing system 102 may be configured to communicate a message to the user device 120. The message may ask for information about different attributes of the person 122a or may ask for permissions to determine attributes about the person 122a from the user device 120.

In some embodiments, the computing system 102 may be configured to generate or augment an individual profile 124a of the person 122a. The individual profile 124a may include any number of attributes of the person 122a and may be associated with the person 122a. For example, the individual profile of the person 122a may be associated with an online marketplace account of the person 122a and may include identification information, address, demographic information, purchase history, geographical information, etc. of the person 122a and that may be included with the marketplace account.

Accordingly, the computing system 102 may be configured to generate or augment the individual profile 124a of the person 122a based on the determined attributes in some embodiments. For example, the computing system 102 may be configured to generate the individual profile 124a for the person 122a based on received (e.g., from the user device 120) identification information associated with the person 122a. In these or other embodiments, the individual profile 124a may already be generated and the computing system 102 may be configured to add to the individual profile 124a.

In some embodiments, the computing system 102 may be configured to include, in the individual profile 124a, the determined sentiment with respect to the stimulus 116. Therefore, the individual profile 124a may indicate how the person 122a may respond to similar stimuli.

In some embodiments, the computing system 102 may be configured to generate or augment one or more group profiles 126 of groups that may share one or more attributes of the person 122a. For example, particular group profile 126 may include a profile of a group of the same or similar age, race, gender, socioeconomic status, purchase history, etc. of the person 122a. The group profiles 126 may include one or more attributes that may be generally common among people who share the attribute that may be used to define the group. For example, a particular group profile 126 may be based on a particular demographic group and may include purchasing patterns, browsing patterns, sentiments, etc. that may be relatively common among the particular demographic group.

In some embodiments, the computing system 102 may be configured to augment or generate one or more group profiles 126 based on one or more of the determined attributes of the person 122a and based on the determined sentiment with respect to the stimulus 116. For example, the determined sentiment may be correlated with a particular stimulus type of the stimulus 116. Further, the determined sentiment with respect to the particular stimulus type may be correlated with one or more other attributes of the person 122a that may correspond to one or more group profiles 126 (e.g., demographic attributes). The computing system 102 may be configured to include the determined sentiment and the corresponding stimulus 116 in one or more of the group profiles 126 that correspond to one or more of the correlated attributes associated with their respective groups.

Additionally or alternatively, the computing system 102 may be configured to augment one or more other individual profiles 124 of one or more other persons 122 who may share one or more attributes of the person 122a. The computing system 102 may be configured to augment the other individual profiles 124 based on one or more attributes of the other persons 122 that may be the same as or similar to one or more of the determined attributes of the person 122a and based on the determined sentiment with respect to the stimulus 116.

For example, the computing system 102 may be configured to access the individual profile 124a and an individual profile 124b of a person 122b. Based on one or more attributes included in the individual profiles 124a and 124b, the computing system 102 may be configured to determine that the person 122a and the person 122b may have a similar demographic profile. The computing system 102 may be configured to direct the inclusion of the determined sentiment and the corresponding stimulus 116, as determined with respect to the person 122a, in the individual profile 124b of the person 122b based on the similar demographic profiles between the person 122a and the person 122b.

In some embodiments, the individual profiles 124 and the group profiles 126 (referred to generally as “profiles”) may be stored in the database 110. The database 110 may be communicatively coupled to the computing system 102 and/or the user device 120 (e.g., via the network 108). As such, the computing system 102 and/or the user device 120 may perform operations that may add to one or more profiles that may be stored in the database 110.

The database 110 may include computer-readable storage media configured to store data. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media.

In some embodiments, the computing system 102 may be configured to determine the suggested action for the person 122a based on one or more of the determined attributes and based on the individual profile 124a and/or one or more of the group profiles 126. For example, the stimulus 116 may include an electronic advertisement or a promotion and the suggested action may include modifying the advertisement or promotion according to preferences included in the individual profile 124a such that the sentiment of the person 122a with respect to the stimulus 116 may be favorable. Additionally or alternatively, the suggested action may include modifying the advertisement or promotion according to a particular group profile 126 of a particular group that may be associated with one or more of the attributes of the person 122a. In these or other embodiments, the suggested action may be based on one or more previously determined sentiments with respect to one or more other stimuli that may be stored in the individual profile 124a or the particular group profile 126.

In these or other embodiments, the computing system 102 may be configured to determine the suggested action for the person 122b that may include an action with respect to the stimulus 116, the person 122b, or a combination of the stimulus 116 and the person 122b. Additionally or alternatively, the computing system 102 may be configured to determine the suggested action while the stimulus 116 is being perceived by the person 122b. Further, in some embodiments, the computing system 102 may be configured to determine the suggested action while the stimulus 116 is being perceived by the person 122b based on the determined sentiment of the person 122a and based on the person 122b having one or more attributes that are the same as or similar to one or more of the attributes of the person 122a.

For example, the computing system 102 may determine a particular sentiment of the person 122a with respect to the stimulus 116. The computing system 102 may also determine one or more attributes of the person 122a, e.g., based on analyzing the images or based on the individual profile 124a of the person 122a as described above. Further, the computing system 102 may be configured to determine that the person 122b is perceiving the stimulus 116, for example in a manner similar to that described above with respect to determining that the person 122a is perceiving the stimulus 116. The computing system 102 may also be configured to determine one or more attributes of the person 122b, e.g., based on analyzing the images or based on the individual profile 124b of the person 122b. The computing system 102 may be configured to determine that one or more of the attributes of the person 122a may be the same as or similar to one or more of the attributes of the person 122b.

Based on the determination that one or more of the attributes between the person 122a and the person 122b may be the same as or similar to each other, the computing system 102 may be configured to determine the suggested action for the person 122b based on the determined sentiment for the person 122a. The suggested action for the person 122b may include an action performed with respect to the stimulus 116 (e.g., changing the stimulus 116), the person 122b (e.g., talking to the person 122b), or a combination of the stimulus 116 and the person 122b. In some embodiments, the computing system 102 may be configured to determine the suggested action based on the individual profile 124a of the person 122a or a particular group profile 126 of a particular group that may be associated with the same or similar attributes between the person 122a and the person 122b. Additionally or alternatively, the suggested action may be modified based on the individual profile 124b of the person 122b. The determination for the person 122b may be performed while the person 122a is still perceiving the stimulus 116 or after the person 122a is done perceiving the stimulus 116.

In some embodiments, the computing system 102 may be configured to determine that a group of people may be perceiving the stimulus 116. In these or other embodiments, the computing system 102 may be configured to determine the sentiment with respect to the stimulus 116 of multiple persons included in the group, as well as one or more attributes that may be common among a portion (e.g., a majority) of the group. The computing system 102 may be configured to include the sentiment in a group profile 126 that may correspond to the group. Additionally or alternatively, the computing system 102 may be configured to determine a suggested action for the group with respect to the persons of the group, the stimulus 116, or a combination of the group and the stimulus. The suggested action may be based on the determined sentiment of multiple persons of the group and/or an associated group profile.

Therefore, the system 102 may be configured to perform operations that may improve an experience of one or more persons with respect to a stimulus. Further, the use of the computing system 102 to make the determinations may allow for real time and constant sentiment analysis that may not be achieved otherwise. In addition, the use of the computing system 102 may provide for determining sentiment based on factors (e.g., heart rate, respiratory rate, subtle body language, etc.) that may not be perceived by a person. As such, the system 100 may include a technical solution to the problem of determining sentiment of persons with respect to a stimulus and responding to the determined sentiment in a manner that may not be achieved otherwise.

Modifications, additions, or omissions may be made to the system 100 without departing from the scope of the present disclosure. For example, the operations described as being performed by specific elements of the system 100 may be performed by one or more different elements of the system 100. Further, one or more of the operations may be performed in a distributed manner across one or more of the elements. In addition, the system 100 may include more or fewer elements than those explicitly listed or described.

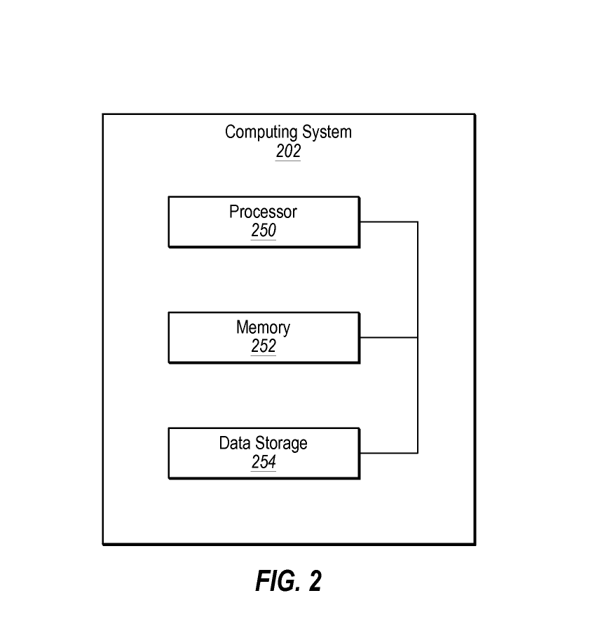

FIG. 2 illustrates a block diagram of an example computing system 202, according to at least one embodiment of the present disclosure. The computing system 202 may include an example of the computing system 102 of FIG. 1. The computing system 202 may include a processor 250, a memory 252, and a data storage 254. The processor 250, the memory 252, and the data storage 254 may be communicatively coupled.

In general, the processor 250 may include any suitable special-purpose or general-purpose computer, computing entity, or processing device including various computer hardware or software modules and may be configured to execute instructions stored on any applicable computer-readable storage media. For example, the processor 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, it is understood that the processor 250 may include any number of processors configured to perform, individually or collectively, any number of operations described herein such as the operations described with respect to the computing system 102 of FIG. 1. Additionally, one or more of the processors may be present on one or more different electronic devices, such as different servers.

In some embodiments, the processor 250 may interpret and/or execute program instructions and/or process data stored in the memory 252, the data storage 254, or the memory 252 and the data storage 254. In some embodiments, the processor 250 may fetch program instructions from the data storage 254 and load the program instructions in the memory 252. After the program instructions are loaded into memory 252, the processor 250 may execute the program instructions.

The memory 252 and the data storage 254 may include computer-readable storage media for carrying or having computer-executable instructions or data structures stored thereon. Such computer-readable storage media may be any available media that may be accessed by a general-purpose or special-purpose computer, such as the processor 250. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 250 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

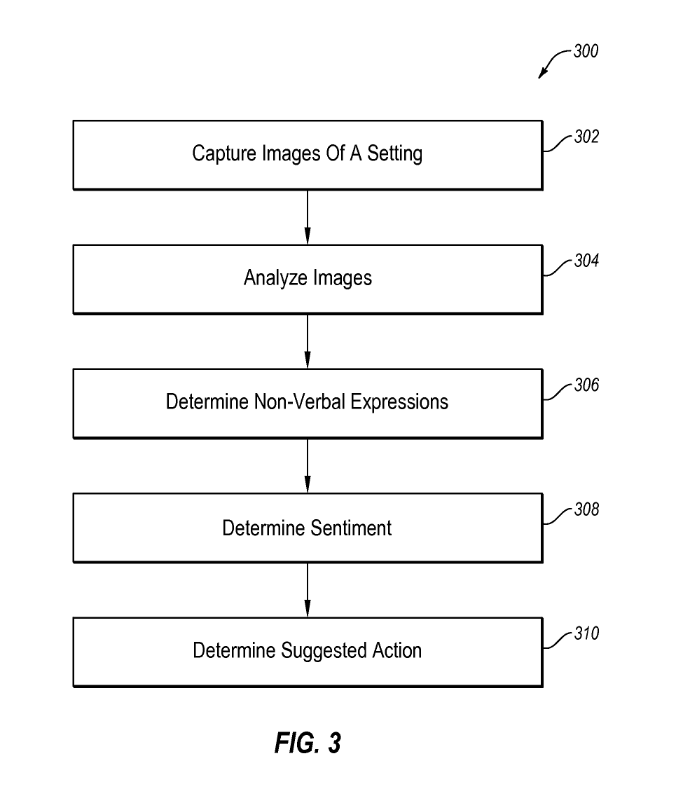

FIG. 3 is a flowchart of an example method 300 to determine a suggested action, according to at least one embodiment described herein. The method 300 may be implemented, in some embodiments, by a system, such as the system 100 of FIG. 1. Although illustrated as discrete blocks, various blocks may be divided into additional blocks, combined into fewer blocks, or eliminated, depending on the desired implementation.

The method 300 may begin, and at block 302 images of a setting may be captured (e.g., by an image capture system). At block 304, the images may be analyzed. In some embodiments, the images may be analyzed in real time.

At block 306, a determination of non-verbal expressions of a person in response to a stimulus being perceived by the person may be made. At block 308, a sentiment of the person with respect to the stimulus may be determined.

At block 310, a suggested action may be determined based on the determined sentiment. The suggested action may include a suggested action with respect to the stimulus, the person, or a combination of the person and the stimulus. In some embodiments, the suggested action may recommend performance of the suggested action while the stimulus is being perceived by the person.

Additionally or alternatively, the suggested action may be based on one or more attributes of the person. Further, the suggested action may be based on an individual profile of the person and/or a group profile of the person. In these or other embodiments, the method 300 may include implementation of the suggested action.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 300 may further include generating a notification while the stimulus is being perceived by the person. The notification may include the suggested action and may be such that another person may receive it and implement the suggested action.

In addition, in some embodiments, the method 300 may include directing the addition of the determined sentiment of the person with respect to the stimulus in an individual profile of the person. In these or other embodiments, the method 300 may include directing the addition of the determined sentiment of the person with respect to the stimulus in a group profile of a group associated with one or more attributes of the person.

As another example, in some embodiments, the stimulus may include an interaction between the person and another person. The method 300 may also include determining non-verbal expressions of the other person and determining sentiment of the person with respect to the non-verbal expressions of the other person. The method 300 may also include determining the suggested action for the other person to modify one or more of his non-verbal expressions.

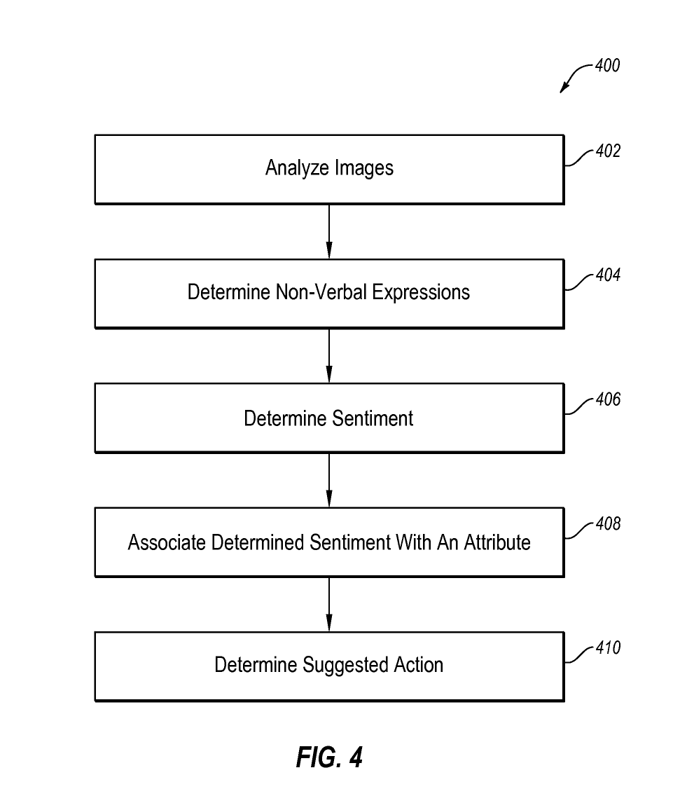

FIG. 4 is a flowchart of another example method 400 to determine a suggested action, according to at least one embodiment described herein. The method 400 may be implemented, in some embodiments, by a system, such as the system 100 of FIG. 1. Although illustrated as discrete blocks, various blocks may be divided into additional blocks, combined into fewer blocks, or eliminated, depending on the desired implementation.

The method 400 may begin, and at block 402, images of a setting that may be captured by an image capture system may be analyzed. In some embodiments, the images may be analyzed in real time.

At block 404, a determination of non-verbal expressions of a first person in response to a stimulus being perceived by the first person may be made. At block 406, a sentiment of the first person with respect to the stimulus may be determined. At block 408, the determined sentiment may be associated with a first attribute of the first person.

At block 410, a suggested action may be determined based on the determined sentiment of the first person. The suggested action may be determined for a second person based on the second person having a second attribute that is the same as or similar to the first attribute of the first person. The suggested action may include a suggested action with respect to the stimulus, the second person, or a combination of the second person and the stimulus in some embodiments. In some embodiments, the suggested action may recommend performance of the suggested action while the stimulus is being perceived by the second person.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 400 may further include determining the first attribute of the first person. The first attribute may be determined based on one or more attribute determination factors that may include a first profile that may be associated with the first person and an analysis of the images. Similarly, the method 400 may further include determining the second attribute of the second person. The second attribute may be determined based on one or more attribute determination factors that may include a second profile that may be associated with the second person and an analysis of the images.

In addition, in some embodiments, the method 400 may include directing the addition of the determined sentiment of the first person with respect to the stimulus in an individual profile of the first person. In these or other embodiments, the method 400 may include directing the addition of the determined sentiment of the first person with respect to the stimulus in a group profile of a group associated with one or more attributes of the first person.

As indicated above, the embodiments described herein may include the use of a special purpose or general purpose computer (e.g., the processor 250 of FIG. 2) including various computer hardware or software modules, as discussed in greater detail below. Further, as indicated above, embodiments described herein may be implemented using computer-readable media (e.g., the memory 252 of FIG. 2) for carrying or having computer-executable instructions or data structures stored thereon.

In some embodiments, the different components, modules, engines, and services described herein may be implemented as objects or processes that execute on a computing system (e.g., as separate threads). While some of the system and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system, comprising:
an image capture system configured to capture images of a setting; and
a computing system communicatively coupled to the image capture system and configured to:
analyze the images in real time;
determine, based on the analysis of the images, first non-verbal expressions captured in the images, the first non-verbal expressions being of a first person in response to a stimulus perceived by the first person;
determine a sentiment of the first person with respect to the stimulus based on the first non-verbal expressions; and
determine, based on the determined sentiment, a suggested action with respect to the stimulus, the first person, or a combination of the stimulus and the first person, the suggested action recommending performance thereof while the stimulus is being perceived by the first person.

2. The system of claim 1, wherein the computing system is further configured to generate a notification for a second person while the stimulus is being perceived by the first person, the notification including the suggested action.

3. The system of claim 1, wherein the computing system is further configured to determine the suggested action based on a profile of the first person.

4. The system of claim 3, wherein the profile includes one or more attributes of the first person selected from a group of attributes including: name, address, age, race, gender, economic status, social status, socioeconomic status, purchase history, browsing history, health conditions, goals, travel plans, travel history, a calendar, event attendance history, a current planned purchase, employment history, profession, education level, employer, educational institutions attended, affiliations, use patterns of an electronic device, previously determined sentiments with respect to previously perceived stimuli, preferences, and planned attendance of an upcoming event.

5. The system of claim 1, wherein the computing system is further configured to determine the suggested action based on a group profile of a group associated with one or more attributes of the first person.

6. The system of claim 1, wherein the computing system is further configured to implement the suggested action such that the stimulus is modified while being perceived by the first person.

7. The system of claim 1, wherein the stimulus includes one or more stimuli selected from a group of stimuli including: an audio stimulus, a visual stimulus, a tactile stimulus, a flavor stimulus, and a situation in which the first person has been placed.

8. The system of claim 1, wherein the stimulus includes an interaction by the first person with a second person and the computing system is further configured to:
determine, based on the analysis of the images, second non-verbal expressions of the second person;
determine the sentiment of the first person with respect to the second non-verbal expressions of the second person; and
determine the suggested action for the second person to modify one or more of the second non-verbal expressions to modify the stimulus.

9. The system of claim 1, wherein the computing system is further configured to direct addition of the determined sentiment with respect to the stimulus to a profile of the first person.

10. The system of claim 1, wherein the computing system is further configured to direct addition of the determined sentiment with respect to the stimulus to a profile of a group associated with one or more attributes of the first person.

11. A system, comprising:
one or more processors; and
computer-readable storage media configured to store instructions that, in response to being executed by the one or more processors, cause the system to perform operations, the operations comprising:
analyzing images of a setting that are captured by an image capture system;
determining, based on the analysis of the images, first non-verbal expressions captured in the images, the first non-verbal expressions being of a first person in response to a stimulus provided to the first person;
determining a sentiment of the first person with respect to the stimulus based on the first non-verbal expressions;
associating the determined sentiment with a first attribute of the first person; and
determining, for a second person, a suggested action with respect to the stimulus, a second person, or a combination of the stimulus and the second person, the suggested action being based on the determined sentiment of the first person and being based on the second person having a second attribute the same as or similar to the first attribute.

12. The system of claim 11, wherein the operations further comprise determining the first attribute based on one or more attribute determination factors selected from a group of attribute determination factors including a first profile associated with the first person and analysis of the images.

13. The system of claim 11, wherein the operations further comprise determining the second attribute based on one or more attribute determination factors selected from a group of attribute determination factors including a first profile associated with the first person and analysis of the images.

14. The system of claim 11, wherein the operations further comprise directing addition of the determined sentiment with respect to the stimulus in an individual profile of the first person.

15. The system of claim 11, wherein the operations further comprise directing addition of the determined sentiment with respect to the stimulus in a group profile of a group associated with the first attribute.

16. The system of claim 11, wherein the operations further comprise analyzing the images in real time.

17. A method comprising:
analyzing images of a setting captured by an image capture system;
determining, based on the analysis of the images, non-verbal expressions captured in the images, the non-verbal expressions being of a person in response to a stimulus perceived by the person;
determining a sentiment of the person with respect to the stimulus based on the non-verbal expressions; and
including the sentiment with respect to the stimulus in a profile of the person.

18. The method of claim 17, further comprising determining, based on the determined sentiment with respect to the stimulus and based on the profile, a suggested action with respect to the person, the stimulus, or a combination of the person and the stimulus.

19. The method of claim 17, further comprising determining a suggested action with respect to another person, the stimulus, or a combination of the another person and the stimulus, the suggested action being determined based on the determined sentiment with respect to the stimulus and based on the another person having a second attribute similar to or the same as a first attribute in the profile.

20. The method of claim 17, further comprising including the sentiment with respect to the stimulus in a group profile of a group associated with one or more attributes of the person that are included in the profile of the person.
